(19) United States
(12) Patent Application Publication
(10) Pub. No.: US 2008/0089169 A1
(43) Pub. Date: Apr. 17, 2008

(54) Loss circulation material blender

(76) Inventors: Billy W. Chrisam, Van Buren, AR (US); Eddie J. Osmus, Duncan, OK (US)

Correspondence Address: MARTIN S. HIGH, P.O. BOX 217, STILLWATER, OK, 74076, US

(21) Appl. No.: 11/549,632

(22) Filed: Oct. 13, 2006

(51) Int. Cl. B01F 13/00; B01F 15/02

(52) U.S. Cl. 366/154.1; 366/162.4

(57) ABSTRACT

The loss circulation material blender, is a device that conveys raw, incoming LCM and mixes this LCM completely and intimately with wet drilling mud. The instant invention is comprised of a dry LCM hopper assembly, a wet mix hopper assembly and a transport frame. The dry LCM hopper assembly is comprised of a dry LCM hopper, a cutting tray, an air inlet, and a conveying means to transport the dry LCM from the dry hopper to the wet mix hopper assembly. The wet mix hopper assembly is comprised of a wet mix chamber, a wet mix chamber track, wet mix chamber slides, a wet mix chamber lid, a wet mix chamber lid hinge, a mud re-circulation line, a mud manifold, a mud manifold bull plug, plurality of mud jets, a dry LCM inlet, and a splatter plate.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING,” A TABLE, OR A COMPUTER PROGRAM LISTING

Not applicable.

### BACKGROUND OF THE INVENTION

1. Field of Invention

The field of the instant invention is the general area of drilling support operations. Specifically, the teaching of the instant invention is directed towards the use of a loss control materials blender to improve the performance of drilling operations by improving the efficiency of the drilling mud used by adding loss control material.

2. Description of Prior Art

The background of the instant invention and the field of the instant invention involves the use and conditioning of drilling muds using materials called loss control materials (hereinafter “LCM”). LCM's are used to prevent the loss of drilling mud down the well bore. Drilling muds are fluids that are pumped down a well. These muds serve several purposes. A primary purpose of the drilling mud is to remove the cuttings of the drill bit by washing away the drill cuttings as drilling progresses. The drilling mud returns to the surface and the drill cuttings are deposited at the surface for disposal. Another purpose of the drilling mud is to power tools and devices placed down the well bore, called downhole tools, such as drilling motors. The drilling mud is pumped into the well at high pressure and this high pressure is used to drive motors downhole.

Given the usefulness of drilling muds and the amount of drilling muds used, it is no surprise that these materials are a significant expense to all drilling operations. Unfortunately, due to the porous nature of the rock present adjacent to the well bore it is common for drilling mud to be lost in the rock formations surrounding the well bore. In many cases, cracks and microcracks form in the formations underground which results in loss of this drilling mud. In many cases, these cracks are present all along the well bore resulting in significant mud losses.

In order to prevent the drilling muds from escaping into the surrounding rock formations, LCM's are used to prevent the flow of mud into the pores of the surrounding rock. LCM's provide a means to reduce the losses of the drilling mud downhole. In essence, the LCM's plug the holes and pores present in the rock formations around the well pore thereby preventing flow of mud into these formations.

LCM are comprised of any cheap material that is capable of plugging the pores downhole. Typically, a LCM is comprised of cottonseed hulls, walnut hulls, cellophane, paper, leaves, or similar cellulosic materials. In short, LCM's can be any material that is capable of being wetted by the drilling mud and can serve to stop the flow of the drilling mud into the cracks formed the in rock formations surrounding the well bore. The LCM is used by chopping the raw LCM into small pieces, mixing these small pieces with the drilling mud, and pumping the LCM and mud mixture downhole. The drilling mud is circulated down the inside of the well pipe and up the annular region between the well pipe and the surface of the surrounding rock formation. Mud is pumped down the well bore and then proceeds outside the bottom of the well bore, up through the annular region, around the drilling tubing and out at the surface. When the mud reaches the surface, it is collected in a series of mud pits to be recycled and pumped down the well again. The mud is collected, cleaned, before it is pumped back down the downhole system. In this manner the drilling mud is circulated downhole in a closed recycle loop.

Introducing the LCM into the mud and forming a mixture that is intimately mixed is a difficult process. Significant mechanical agitation is required to wet the LCM by contacting it with the wet mud and mix the mud-LCM mixture for use in pumping downwell. Prior art teaches processes that typically use a mechanical means to mix fine LCM solids with liquids. Therefore, a means to reduce the particle size of the raw LCM is a required first step in the inventions taught by the prior art. In many cases, these mechanical devices are not capable of handling the volumes required in drilling applications and also involve significant amount of clogging of the solids material. A primary goal of the instant invention is to develop a means of mixing the loss circulation materials with the drilling mud to be used and pumped down well without clogging and without a separate step of size reduction before mixing.

### BRIEF SUMMARY OF THE INVENTION

The instant invention, the loss circulation material blender, is a device that conveys raw, incoming LCM and mixes this LCM completely and intimately with wet drilling mud. This invention also teaches the method of using the LCM material blending technique. The instant invention is comprised of a dry LCM hopper assembly, a wet mix hopper assembly and a transport frame. The dry LCM hopper assembly is comprised of a dry LCM hopper, a cutting tray, an air inlet, and a conveying means to transport the dry LCM from the dry hopper to the wet mix hopper assembly.

The wet mix hopper assembly is comprised of a wet mix chamber, a wet mix chamber track, wet mix chamber slides, a wet mix chamber lid, a wet mix chamber lid hinge, a mud re-circulation line, a mud manifold, a mud manifold bull plug, plurality of mud jets, a dry LCM inlet, and a splatter plate. The dry LCM inlet is connected to the dry LCM transport hose. The dry LCM transport hose conveys dry, chopped LCM from the dry LCM hopper to the wet mix hopper assembly via the LCM transport hose. A pair of wet mix chamber slides are affixed to the bottom and slides of the wet mix hopper assembly and slide on top of a pair of tracks to position the wet hopper assembly over the correct mud pit. The transport frame is comprised of the transport frame supports and safety guards. The transport frame also serves as a dry LCM hopper assembly support and allows the dry LCM hopper assembly to be mounted on top of the transport frame.

In this respect, before explaining at least one embodiment of the invention in detail, it is to be understood that the invention is not limited in this application to the details of construction and to the arrangements of the components set forth in this summary, the following detailed description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### BRIEF DESCRIPTION OF THE SEVERAL VIEWS OF THE DRAWING

FIG. 1 is a schematic of the orientation of the instant invention relative to the LCM supply truck and the mud supply pits.

FIG. 2 is a schematic of the dry LCM hopper assembly.

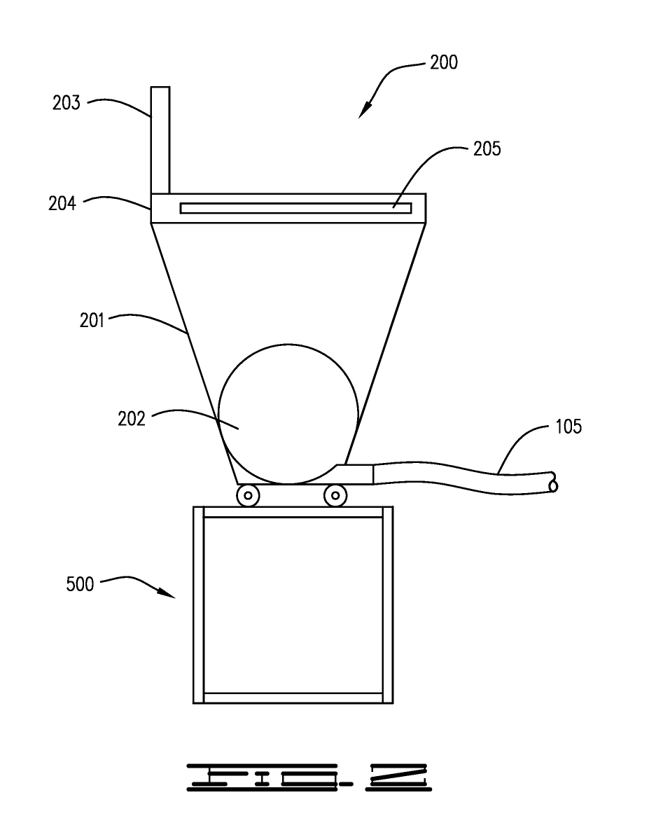

FIG. 3 is a schematic of the wet LCM hopper assembly.

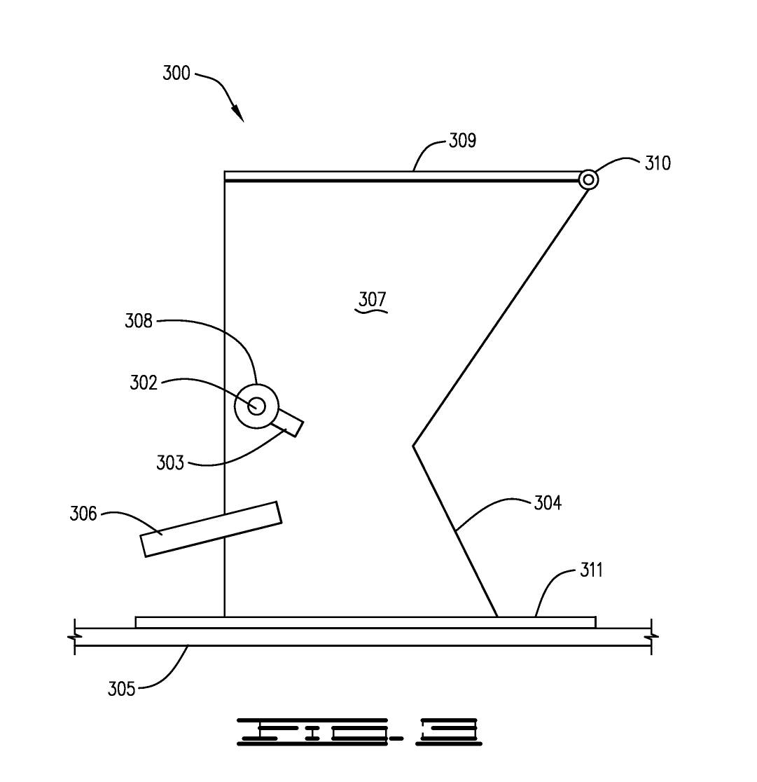

FIG. 4 is a schematic of the mud jets and the discharge of the dry LCM hose.

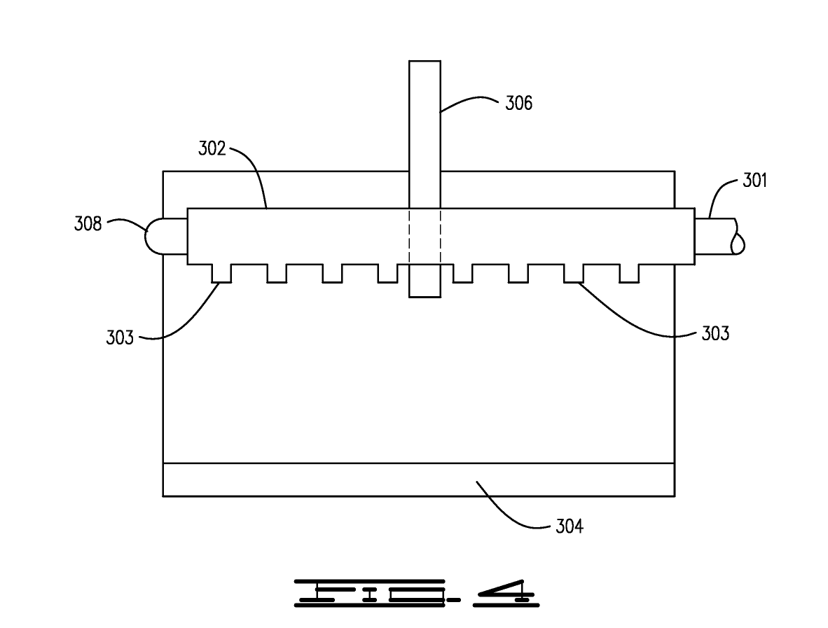

FIG. 5 is an illustration of the instant invention stored in the frame in the transportation-ready configuration.

FIG. 6 is another illustration of the instant invention stored in the frame in the transportation-ready configuration.

### DETAILED DESCRIPTION OF THE INVENTION

The instant invention, the loss circulation material blender, is a device that conveys raw, incoming LCM and mixes this LCM completely and intimately with wet drilling mud. In its most general configuration, the loss control material blender comprises an air moving means for creating an airflow, an LCM mixing means for adding the LCM to the air flow, transport piping or hoses, a mud pumping means, and a mixing means for adding LCM to the mud. More specifically, the instant invention is comprised of a dry LCM hopper assembly 200, a wet mix hopper assembly 300 and a transport frame 500.

The dry LCM hopper assembly 200 is comprised of a dry LCM hopper 201, a cutting tray 204, an air inlet 203, and a conveying means to transport the dry LCM from the dry hopper to the wet mix hopper assembly. The cutting tray 204 is further comprised of an impeller 205. As raw LCM material is added to the LCM hopper, the LCM passes into the cutting tray 204 and through the impeller 205. The impeller 205 serves to reduce the size of the LCM materials through vigorous mechanical motion. In one preferred embodiment of the instant invention, the conveying means is a dry LCM blower 201 and a dry LCM transport hose 105. In one preferred embodiment of the instant invention the dry LCM blower is a rotary vane blower. The dry LCM blower receives dry LCM from the dry LCM hopper 201 via the impeller 205 and conveys the dry LCM through the LCM transport hose 105 to the wet mix hopper assembly 300. The movement of LCM through the LCM hopper, the cutting tray 204 and the impeller 205 is aided by compressed air that is introduced to the dry LCM hopper 201 via the air inlet 203. In the process of being transported through the dry LCM blower 201, the dry LCM is reduced in size further in the conveying means. For example, in the preferred embodiment of the instant invention using a rotary blower, the blower decreases the size of the dry LCM further through the vigorous mechanical action of the blower.

The wet mix hopper assembly 300 is comprised of a wet mix chamber 307, a wet mix chamber track 305, wet mix chamber slides 311, a wet mix chamber lid 309, a wet mix chamber lid hinge 310, a mud re-circulation line 301, a mud manifold 302, a mud manifold bull plug 308, plurality of mud jets 303, a dry LCM inlet 306, and a splatter plate 304.

The dry LCM inlet 306 is connected to the dry LCM transport hose 105. The dry LCM transport hose conveys dry, chopped LCM from the dry LCM hopper assembly 200 to the wet mix hopper assembly 300 via the LCM transport hose 105. The dry LCM inlet 306 introduces the dry LCM to the wet mix hopper 300 at high velocity and pressure to be mixed with the re-circulating mud.

A pair of wet mix chamber slides 311 are affixed to the bottom and slides of the wet mix hopper assembly 300. These slides 311 are located on the sides and bottom of the wet mix hopper assembly 300 and allow the wet mix hopper assembly 300 to slide along a pair of tracks 305 affixed to the top of the mud pits. In most applications, a plurality of mud pits are used for various purposes including serving as a suction pit and a storage pit. The wet mix hopper assembly 300 is located atop of a these multi-chamber mud pits, and LCM must be discharged into a selected pit. Through the use of the slides 311 and tracks 305 the wet mix hopper assembly 300 can be positioned as needed along the tracks 305 and on top of a selected mud pit.

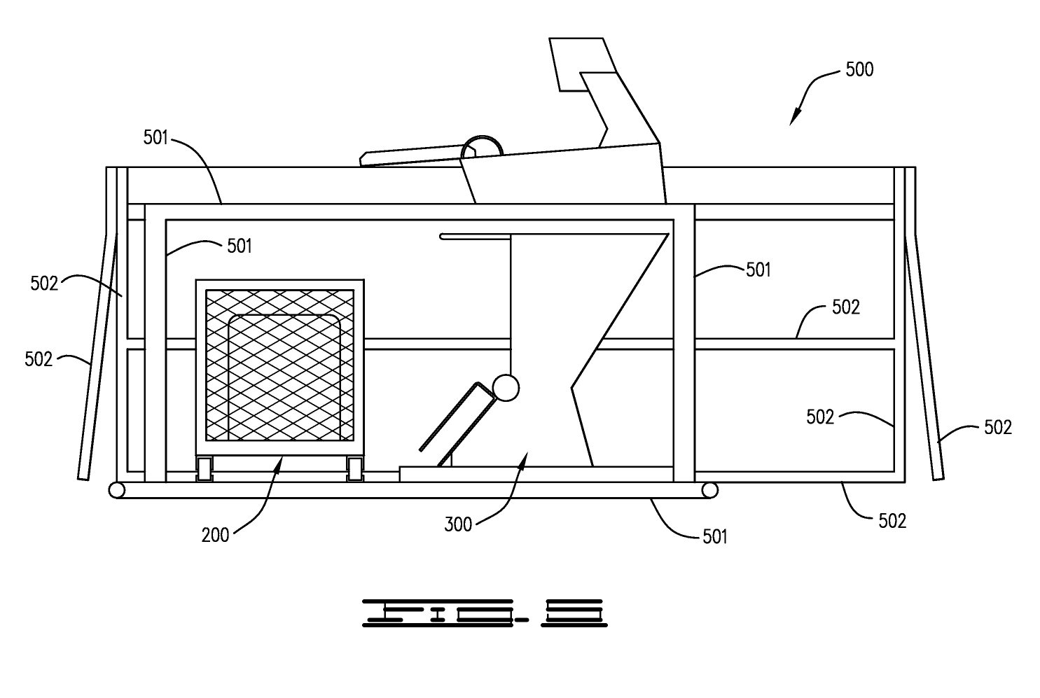

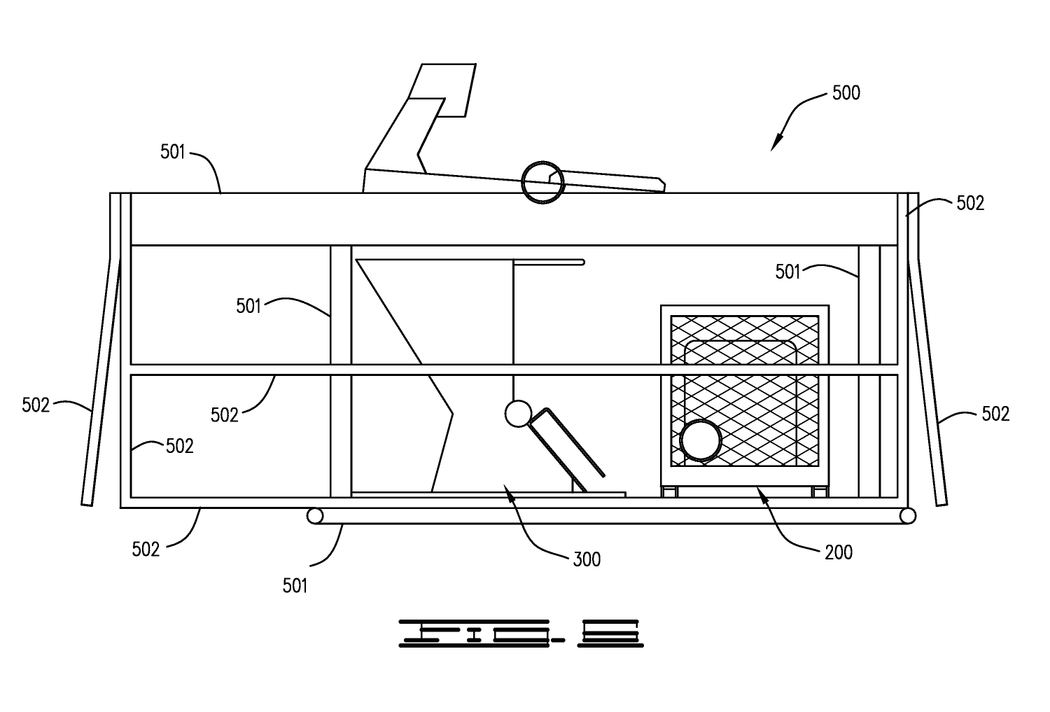

The transport frame is comprised of the transport frame supports 501 and safety guards 502. The components of the instant invention, the dry LCM hopper assembly 200 and the wet mix hopper assembly 300, can be positioned inside a transport frame 500. The entire instant invention with the components configured within the transport frame (see FIG. 5 and FIG. 6) can be easily transported with a small truck such as a pick-up truck.

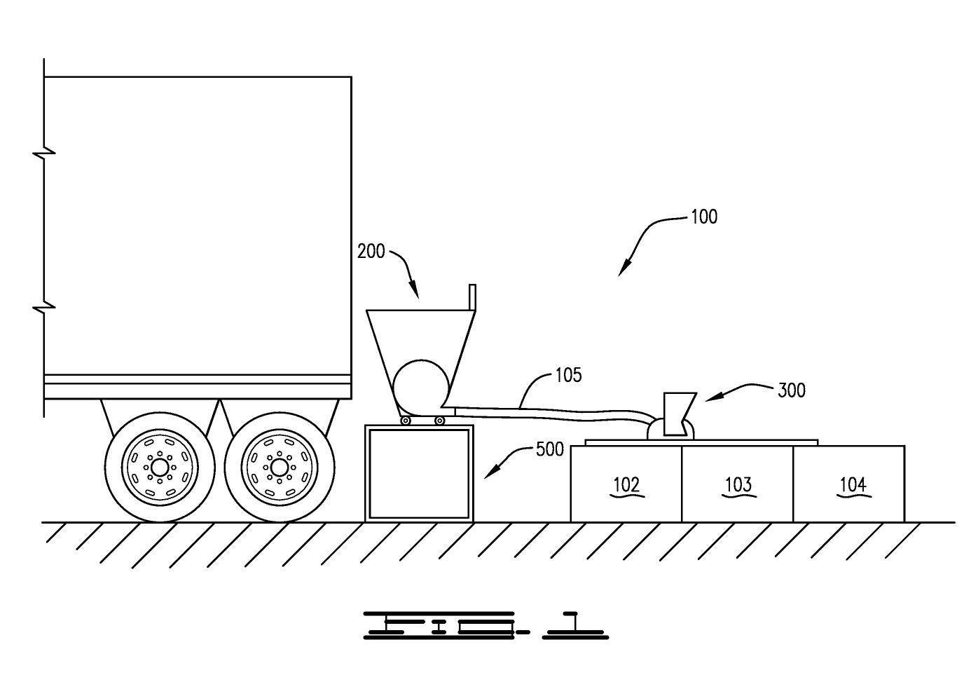

The transport frame 500 also serves as a dry LCM hopper assembly support and allows the dry LCM hopper assembly 200 to be mounted on top of the transport frame 500. Mounting the dry LCM hopper assembly 200 on top of the transport frame 500 allows for LCM to be easily unloaded from a truck into the dry LCM hopper assembly 200 as depicted in FIG. 1. In this configuration, the safety guards 502 are rotated upwards and locked in place to protect users from accidentally falling into the dry LCM hopper assembly 200 and being injured.

In the best mode of use of the instant invention the components of the instant invention, the dry LCM hopper assembly 200 and the wet mix hopper assembly 300, are unpacked from the transport frame 500. The transport frame 500 is placed near an unloading position for a truck. The dry LCM hopper assembly 200 is placed on top of the transport frame 500. The wet mix hopper assembly 300 is placed on top of the mud pits 102 so that the slides 311 engaged with the tracks 305. The wet mix hopper assembly 300 is then positioned under the pre-mix pit 102, the suction pit 103, or the storage pit 104, or another pit as the application requires. The LCM transport hose 105 is connected to the dry LCM hopper assembly 200 and the wet mix hopper assembly 300.

In the best mode operation of the instant invention, as material is unloaded from the truck as illustrated in FIG. 1 material is placed inside the dry LCM hopper assembly 200. The dry LCM is blown into the cutting tray 204 through the impeller 205 where the first size reduction of the LCM takes place. The compressed air from the air inlet 203 blows the dry LCM down further into the dry LCM hopper 201. The chopped LCM is conveyed into the blower 202 where further size reduction takes place. The blower 202 conveys the LCM material to the wet mix hopper assembly 300.

In the wet mix hopper assembly 300, mud being pumped from a mud re-circulation pump is forced into the mud re-circulation line 301. The mud is injected into the manifold 302 and then is discharged from the manifold in the plurality of mud jets 303. LCM from the dry LCM hopper assembly 200 is transported through the LCM transport hose 105 and into the dry LCM inlet 306. The LCM is discharged from the dry LCM inlet 306 at high velocity and pressure into the wet mix chamber 307.

The wet mud being discharged from the plurality of mud jets 303 and the dry LCM being discharged from the LCM inlet 306 intersect and strike each other in the vicinity of the splatter plate 304. As dry LCM is impinges the mud the LCM becomes intermixed with the mud. Further mixing occurs as the mixed streams strike the splatter plate 304. As the LCM-mud mixture falls down the splatter plate, the LCM continues to intermix with the mud. Lastly, the LCM-mud mixture falls out the bottom of the wet mix hopper assembly 300 and into the mud pit over which wet mix hopper assembly 300 is positioned. At this point the mud with the LCM is pumped down hole to provide the necessary function of the mud and LCM.

What is claimed is:

1) A loss control material blender comprising
an air moving means for creating an airflow,
an LCM mixing means for adding the LCM to the air flow,
transport piping,
mud pumping means, and
mixing means for adding LCM to the mud.

2) The loss control material blender described in claim 1 where
the LCM mixing means is a dry LCM hopper assembly, and
the mixing means to for adding LCM to the mud is a wet mix hopper assembly.

3) The loss control material blender described in claim 2 where the dry LCM hopper assembly is comprised of
a dry LCM hopper,
a cutting tray,
an air inlet,
a blower, and
where the conveying means is
a dry LCM rotary blower, and
a dry LCM transport hose.

4) The loss control material blender described in claim 2 where the wet mix hopper assembly is comprised of
a wet mix chamber,
a mud manifold,
plurality of mud jets,
a splatter plate, and
the means to mix the wet mud with the dry LCM is accomplished by impinging the output stream from the plurality of mud jets and the output from a dry LCM inlet line together to effect mixing.

5) The loss control material blender described in claim 4 where the means to mix the wet mud with the dry LCM is comprised of the mixed streams impinging on a splatter plate to further mix the LCM and the mud.

6) The loss control material blender described in claim 5 where the wet mix hopper assembly is comprised of
a pair of wet mix chamber tracks,
a pair of wet mix chamber slides,
a wet mix chamber lid,
a wet mix chamber lid hinge,
a mud re-circulation line, and
a mud manifold bull plug.

7) The wet mix hopper assembly comprised of
a wet mix chamber,
a mud manifold,
a plurality of mud jets,
a splatter plate, and
the means to mix the wet mud with the dry LCM is accomplished by impinging the output stream from the plurality of mud jets and the output from a dry LCM inlet line together to effect mixing.

8) A method of using a loss control material blender comprising
an air moving means for creating an airflow,
an LCM mixing means for adding the LCM to the air flow,
a means of transporting dry LCM,
mud pumping means, and
mixing means for adding LCM to the mud.

9) The method of using a loss control material blender described in claim 8 comprising
a dry LCM hopper assembly,
a wet mix hopper assembly,
a means to mix the wet mud with the dry LCM, and
a conveying means.

10) The method of using a loss control material blender described in claim 8 where the dry LCM hopper assembly is comprised of
a dry LCM hopper,
a cutting tray,
an air inlet,
a blower, and
where the conveying means is
a dry LCM rotary blower, and
a dry LCM transport hose.
